(19) United States
(12) Patent Application Publication
(10) Pub. No.: US 2012/0025946 A1
(43) Pub. Date: Feb. 2, 2012

(54) ELECTRONIC DEVICE WITH REMOTE FUNCTION

(75) Inventors: PING-YANG CHUANG, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 12/949,815

(22) Filed: Nov. 19, 2010

(30) Foreign Application Priority Data
Jul. 29, 2010 (TW) 99125207

(51) Int. Cl. G05B 19/02

(52) U.S. Cl. 340/4.3

(57) ABSTRACT

An electronic device includes a storage unit, a motion sensor, a remote signal generating unit, a processing unit, and a transmitting unit. The storage unit stores a control table recording a number of remote controlled devices, a number of movements of the electronic device, and a number of control commands. Each remote controlled device is associated with at least one of the movements. Each movement corresponds to one control command. The motion sensor is to sense movement of the electronic device. The processing unit is to search in the control table to determine the control command the sensed movement corresponding to according to the sensed movement and a selected remote controlled device, and further to control the remote signal generating unit to generate a remote signal corresponding to the control command. The transmitting unit transmits the remote signal to the selected remote controlled device.

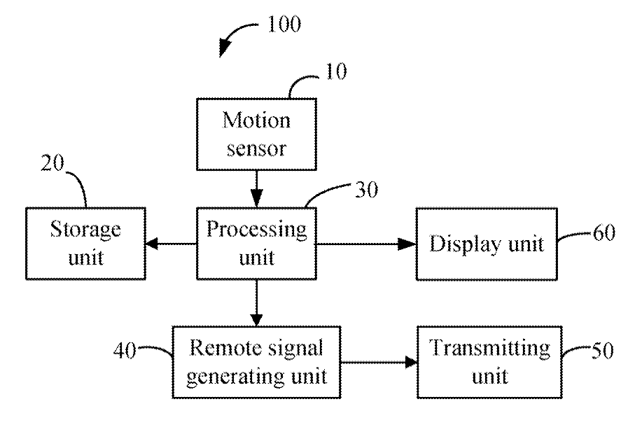

### BACKGROUND

1. Technical Field

The present disclosure relates to electronic devices and, particularly, to an electronic device having remote function.

2. Description of Related Art

Nowadays people usually use remote controls having quite a few keys to operate electronic devices, like TVs, for example. However, these remote controls may not be fit for users to operate in a dark environment.

### BRIEF DESCRIPTION OF THE DRAWINGS

The components of the drawing are not necessarily drawn to scale, the emphasis instead being placed upon clearly illustrating the principles of an electronic device with remote function.

The drawing is a block diagram of an electronic device with remote function in accordance with an exemplary embodiment.

### DETAILED DESCRIPTION

Referring to the drawing, an embodiment of an electronic device 100 is illustrated. The electronic device 100 may be a wearable device or a handheld device, such as, a wristwatch, or a mobile phone. The electronic device 100 can remotely control peripheral devices (not shown), such as TVs, or RC cars.

The electronic device 100 includes a motion sensor 10, a storage unit 20, a processing unit 30, a remote signal generating unit 40, a transmitting unit 50, and a display 60.

The motion sensor 10 senses movement of the electronic device 100. The motion sensor 10 can include an acceleration sensor. The acceleration sensor may be a two-axis or a three axis acceleration sensor. The motion sensor 10 can further include a gyroscope.

The storage unit 20 stores a control table (shown below). The control table records a number of remote controlled devices (hereinafter, RC devices), a number of movements of the electronic device 100, and a number of control commands. Each RC device is associated with at least one of the movements, that is, each RC device can be controlled to execute at least one function by at least one of the movements of the electronic device 100. Each movement corresponds to one control command. The same movements associated with different RC devices may correspond to different control commands. As shown below, the first movement associated with the RC device A corresponds to the first control command, and the first movement associated with the RC device B corresponds to the third control command different from the first control command. That is, if the electronic device 100 is employed to control the RC device A, the first movement of the electronic device 100 controls the RC device A to execute a function. If the electronic device 100 is employed to control the RC device B, the first movement of the electronic device 100 controls the RC device B to execute another function.

Control Table

| RC Device | Movement | Control Command |
|---|---|---|
| A | First Movement | First Control Command |
| | Second Movement | Second Control Command |
| B | First Movement | Third Control Command |
| . . . | . . . | . . . |

The processing unit 30 is configured to display a user interface (not shown) on the display 60 for users to select a RC device. The processing unit 30 is configured to determine which RC device is selected, and search in the control table to determine the control command the sensed movement of the electronic device 100 corresponding to according to the sensed movement and the selected RC device, and further configured to control the remote signal generating unit 40 to generate a remote signal corresponding to the determined control command. The transmitting unit 50 is configured to transmit the remote signal to the selected RC device to control the selected RC device to execute a predetermined function.

With such configuration, if the electronic device 100 is moved according to predetermined movements, the electronic device 100 can conveniently control a selected RC device.

For better understanding the present disclosure, an example is given to illustrate the present disclosure. In this example, the electronic device 100 is a wristwatch on the wrist of a user, and the selected RC device is a TV. The movement of the wrist to the left, that is, the movement of the wristwatch to the left, is predetermined to turn on the TV, and the movement of the wrist to the right, that is, the movement of the wristwatch to the right, is predetermined to turn off the TV. If the wrist moves to the left, the motion sensor 10 senses the movement of the wristwatch. The processing unit 30 determines that the movement of the wristwatch is employed to turn on the TV according to the control table, and controls the remote signal generating unit 40 to generate the remote signal for turning on the TV. The transmitting unit 50 then transmits the remote signal to turn on the TV. If the wrist moves to the right, the motion sensor 10 senses the movement of the wristwatch. The processing unit 30 determines that the movement of the wristwatch is employed to turn off the TV according to the control table, and controls the remote signal generating unit 40 to generate the remote signal for turning off the TV. The transmitting unit 50 then transmits the remote signal to turn off the TV.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with remote function, comprising:
a storage unit storing a control table, the control table recording at least one remote controlled device, at least one movement of the electronic device, and at least one control command, each of the at least one remote controlled device being associated with at least one of the at least one movement, and each of the at least one movement corresponding to one of the at least one control command;
a motion sensor to sense movement of the electronic device;
a remote signal generating unit;
a processing unit to determine which of the at least one remote controlled device is selected, and search in the control table to determine the control command the sensed movement corresponding to according to the movement sensed by the motion sensor and the selected remote controlled device, and further to control the remote signal generating unit to generate a remote signal corresponding to the determined control command; and
a transmitting unit configured to transmit the remote signal to the selected remote controlled device.

2. The electronic device as described in claim 1, wherein the processing unit is further to provide a user interface for users to select one of the at least one remote controlled device.

3. The electronic device as described in claim 1, wherein the motion sensor comprises an acceleration sensor.

4. The electronic device as described in claim 1, wherein the motion sensor further comprises a gyroscope.

5. The electronic device as described in claim 3, wherein the acceleration sensor is a two-axis acceleration sensor.

6. The electronic device as described in claim 3, wherein the acceleration sensor is a three-axis acceleration sensor.

7. The electronic device as described in claim 1, wherein the electronic device is a wristwatch.
